(19) United States
(12) Patent Application Publication
(10) Pub. No.: US 2018/0029816 A1
(43) Pub. Date: Feb. 1, 2018

(54) MULTIPURPOSE RETAINER KIT

(71) Applicant: Mary G. Cain, Milwaukee, WI (US)

(72) Inventor: Mary G. Cain, Milwaukee, WI (US)

(21) Appl. No.: 15/639,344

(22) Filed: Jun. 30, 2017

Related U.S. Application Data
(60) Provisional application No. 62/367,220, filed on Jul. 27, 2016.

(51) Int. Cl. B65H 16/04; A47K 10/22; B26B 29/04; B65H 27/00

(52) U.S. Cl. CPC B65H 16/04; B65H 27/00; A47K 10/22; B26B 29/04

(57) ABSTRACT

A multipurpose retainer adapted to be used as a roller dispenser and for safely storing scissors or shears is providing in a kit including a base; a tubular element extending from a distal end to a proximal end, the proximal end transversely connected to the base; a plurality of stopper bolts, each stopper bolt providing a body and a flange portion, wherein a flange diameter of the flange portion is greater than a body diameter of the body, and wherein the body diameter fits within a lumen of the tubular element, while the flange diameter does not; and a donut opening disposed in each flange portion for receiving the scissors of shears.

### CROSS-REFERENCE TO RELATED APPLICATION

This application claims the benefit of priority of U.S. provisional application Ser. No. 62/367,220, filed 27 Jul. 2016, the contents of which are herein incorporated by reference.

### BACKGROUND OF THE INVENTION

The present invention relates to multipurpose retainers and, more particularly, a multipurpose retainer adapted to be used as a roller dispenser and for safely storing scissors or shears in a logical home from which and to which users can quickly find and return them.

Currently, rolled-materials dispensers serve only to be operatively associated with the rolled materials. Furthermore, prior to the present invention, there has not been a standardized way to store scissors or shears so that they are visually accessible, readily available, and safely stored.

Rolled materials dispensers, such as for paper towels, are found in workshops, workrooms, and kitchens; however, such dispensers take up valuable counter space or under-cabinet space while only performing a single function. None of them provide additional functions such as storage for tools like scissors that would justify this. Also, current dispensers do not have attractive or interesting tops that scissors could provide.

Scissors and shears are useful tools especially in the kitchen. But they are easily misplaced or lost, making them difficult to find when you need them. This extra effort is a waste of time and energy. Scissors can be stored in knife blocks but those take up valuable counter space as well. Current scissor storage does not work well because it is not standardized and lacks efficiency in locating them, for example, scissors can be stored in a drawer but that requires extra effort to open and close a drawer.

As can be seen, there is a need for a multipurpose retainer adapted to be used as a roller dispenser and for safely storing scissors or shears in a logical home from which and to which users can quickly find and return them.

### SUMMARY OF THE INVENTION

In one aspect of the present invention, kit for operatively dispensing rolled material and simultaneously storing elongated tapered objects includes a base; a tubular element extending from a distal end to a proximal end, the proximal end transversely connected to the base; a plurality of stopper bolts, each stopper bolt providing a body and a flange portion, wherein a flange diameter of the flange portion is greater than a body diameter of the body, and wherein the body diameter fits within a lumen of the tubular element, while the flange diameter does not; and a donut opening disposed in each flange portion.

In another aspect of the present invention, the kit for operatively dispensing rolled material and simultaneously storing elongated tapered objects includes a base; a tubular element extending from a distal end to a proximal end, the proximal end transversely connected to the base; a plurality of stopper bolts, each stopper bolt providing a body and a flange portion, wherein a flange diameter of the flange portion is greater than a body diameter of the body, and wherein the body diameter fits within a lumen of the tubular element, while the flange diameter does not; a donut opening disposed in each flange portion; each flange portion provides a diameter of the donut opening that differs among the plurality of stopper bolts; the lumen and each body provides cooperating threading; and each body provides at least one staggered opening, each staggered opening having a diameter greater than a diameter of the respective donut opening.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a perspective view of an exemplary embodiment of the present invention;

FIG. 3 is an exploded view of an exemplary embodiment of the present invention;

FIG. 4 is a section view of an exemplary embodiment of the present invention, taken along line 4-4 of FIG. 1;

FIG. 5 is an enlarged section view of an exemplary embodiment of the present invention;

FIG. 6 is a top view of an exemplary embodiment of the present invention;

FIG. 7 is a bottom view of an exemplary embodiment of the present invention;

FIG. 8 is a perspective view of an exemplary embodiment of the present invention;

FIG. 9A is a top view of an exemplary embodiment of the present invention;

FIG. 9B is a section view of an exemplary embodiment of the present invention, taken along line 9B-9B of FIG. 9A;

FIG. 10A is a top view of an exemplary embodiment of the present invention; and

FIG. 10B is a section view of an exemplary embodiment of the present invention, taken along line 10B-10B of FIG. 10A.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides multipurpose retainer adapted to be used as a roller dispenser and for safely storing scissors or shears in a logical home from which and to which users can quickly find and return them.

### ITEMIZED PARTS LIST

10 weighted base (Approx. Diameter: 6″-6½″; Approx. Height: ¾″-1¼″)
12 base cover
14 tubular element (Approx. Diameter: 1″-1⅝″; Approx. Height: 9″-10½″;
Approx. Thickness of tube material: 1/64″- 1/32″)
16 female threading
18 mat (Approx. Diameter: 5″-6½″;)
20 secondary fastener
22 elongated fastener
24 large stopper bolt (Approx. Outside Diameter: 1″-1⅝″; Approx. Inside Diameter: ¾″-1½″; Approx. Height: ½″-2″)
26 medium stopper bolt (Approx. Outside Diameter: 1″-1⅝″, Approx. Inside Diameter: ½″-¾″; Approx. Height: ½″-2″)
28 small stopper bolt (Approx. Outside Diameter: 1″-1⅝″; Approx. Inside Diameter: ¼″-½″; Approx. Height: ½″-2″)
30 adhesive
32 tubular item
34 elongated object
36 mounting base
38 vertical supporting surface

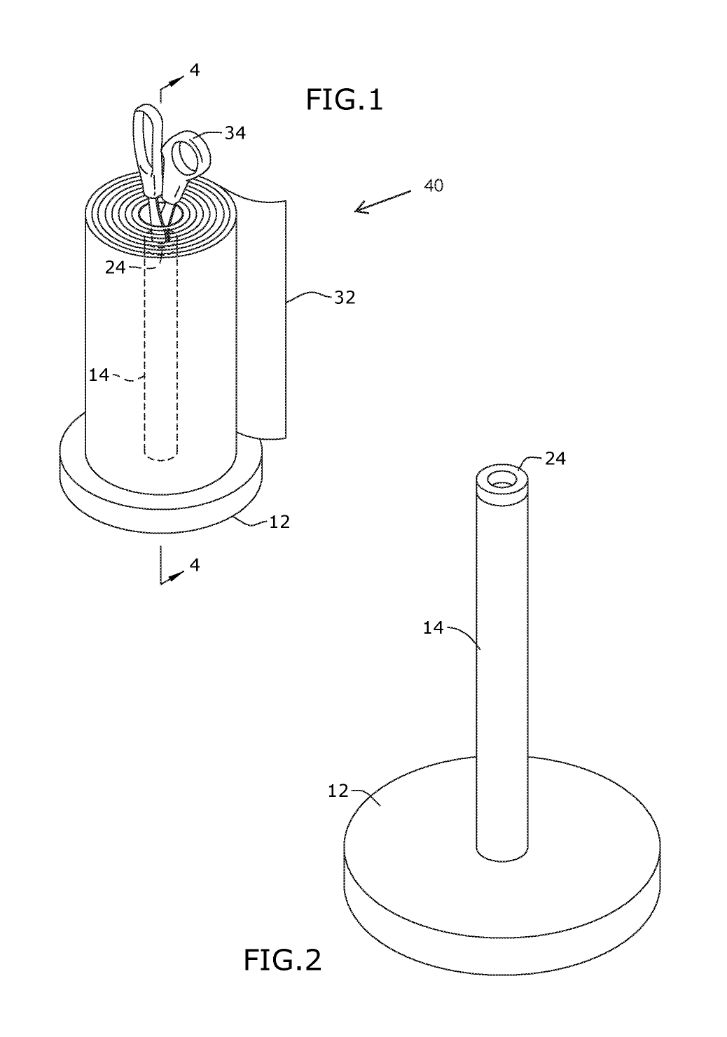

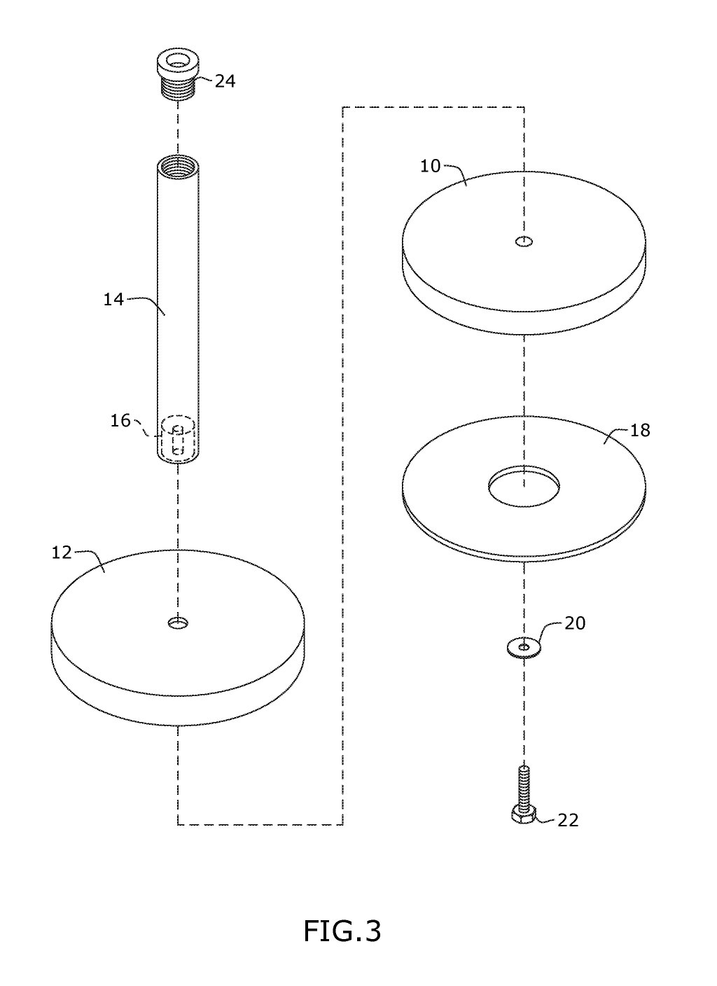

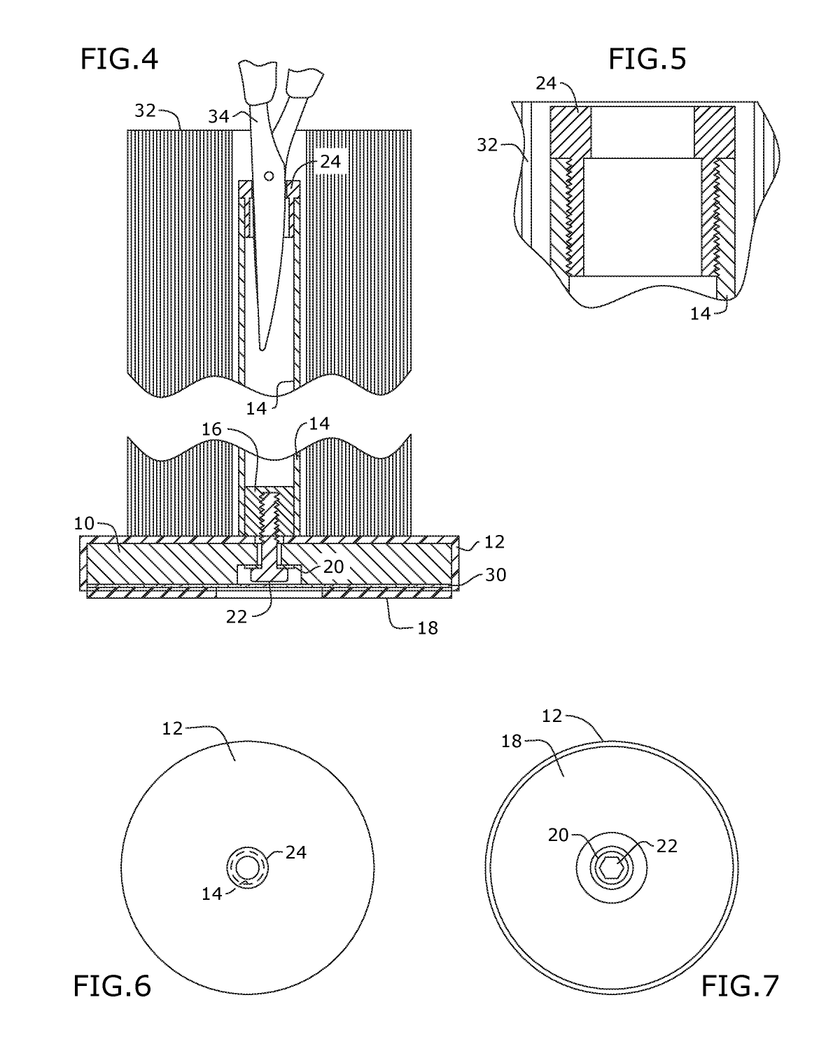

Referring now to FIGS. 1 through 10B, the present invention may include a multipurpose retainer 40. The multipurpose retainer 40 may be made of material of sufficient strength to resist the loads disclosed herein. The multipurpose retainer 40 and its associated components may be various materials, colors and shapes as long as they function in accordance with the disclosure herein. The multipurpose retainer 40 may include a tubular member 14 removably joined at its proximal end to a weighted base 10, so as to extend generally perpendicularly from the weighted base 10 to a distal end. The weighted base 10 may be generally planar with a first and second opposing surface. The weighted base 10 may be any shape that enables the first surface to rest on a generally horizontal supporting surface. The weighted base 10 may provide a centrically disposed fastener opening.

The present invention may provide a base cover 12 dimensioned and adapted to slide over the second and side surfaces of the weighted base 10, wherein the base cover 12 provides a centrically disposed cover opening that aligns with the fastener opening. The present invention may provide a mat 18 of non-slip material providing a centrically disposed mat opening so that when the mat 18 adheres to a portion of the first surface by way of an adhesive 30 the mat opening aligns with the fastener opening.

The tubular element 14 has an exterior and interior diameter, with the interior diameter defining the lumen of the tubular element 14. The proximal end of the tubular element 14 may provide integrated female threading 16 along its interior diameter, so that an elongated fastener 22 having complementary male threading (such as a bolt) may slide through the mat, base, and cover opening and join the tubular element 14 to the weighted base 10. A secondary fastener 20, such as a washer, may be employed with the elongated fastener 22, as illustrated in the figures.

The present invention may provide a plurality of stopper bolts 24-28, each adapted to snugly slide into the distal end of the lumen of the tubular member 14, wherein each stopper bolt provides a flange element having greater exterior diameter than the interior diameter (of the lumen) so as to “catch” on a periphery of the distal end of the tubular element 14. Each stopper bolt provides a different sized ‘donut’ opening for slidably receiving different sized elongated objects 34 therein. Each stopper bolt, may have a staggered or tiered opening, wherein the opening associated with the flange element has a diameter greater than a diameter associated with the remaining portion of the donut opening, as illustrated in FIGS. 5, 6 9A-10B, thereby facilitating retaining elongated objects 34 have various widths, especially ones that terminate in a portion having a greater width than that of the elongated portion. Each stopper bolt may be made of an antimicrobial material, such as antimicrobial-treated silicone. The stopper bolts may come in a set of three: a first stopper, a second stopper, and a third stopper, each with a different sized donut opening. For example, the first donut opening may have a first diameter of one-half inch, while the second donut opening may have a second diameter of three-quarter inch, and while the third donut opening may have a third diameter of one inch.

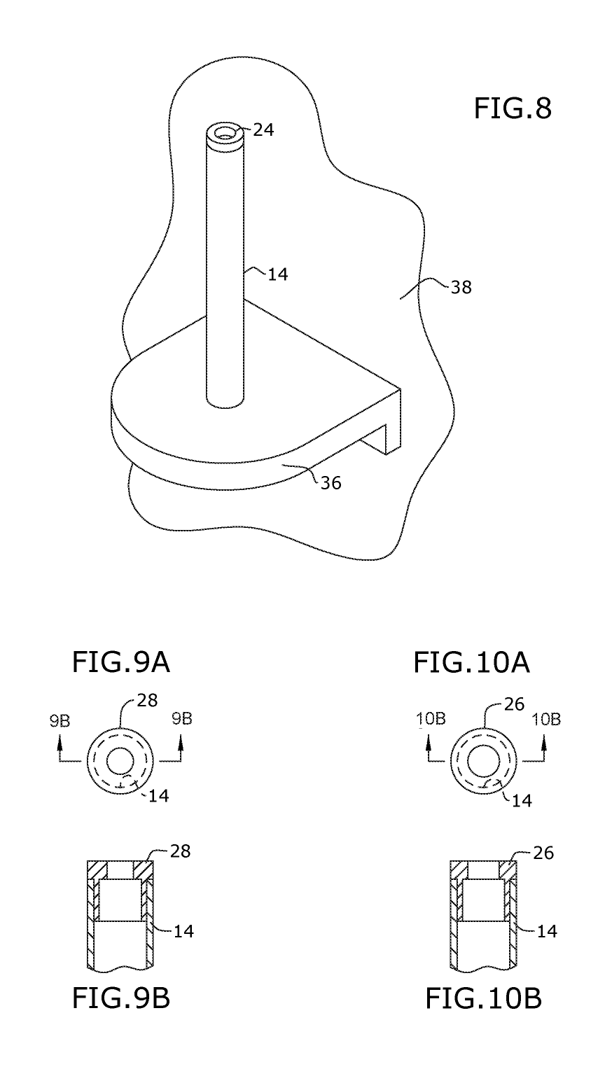

In certain embodiments, the multipurpose retainer 40 may have a mounting base 36 adapted to secure to a vertical supporting surface 38, as illustrated in FIG. 8.

A method of using the present invention may include the following. The multipurpose retainer 40 disclosed above may be provided. A user may join the tubular element 14 to the weighted base 10, thereby allowing the user to slide thereon a tubular item 32, such as a paper towel roll, so as to rotatably engage the tubular item 32 and the tubular element 14. Then the user may choose one desired stopper bolt of the plurality of stopper bolts 24-28, and attach the desired stopper bolt to the distal end of the tubular element 14. Then the user may slide a predetermined elongated object 34, such as a pair of scissors, into the donut opening associated with the desired stopper bolt, wherein a closed pair of scissors or shears may be secured in the lumen of the tubular element 14 so that handles of the scissors are displayed above the tubular element 14 and the tubular item 32 so that the latter is still selectively operable. The user may change or interchange a new stopper bolt along the rim of the distal end of the tubular element 14 to accommodate larger or smaller scissors/shears/elongated object 34.

Additionally, the present invention could be used to hold and store objects other than scissors/shears. It could hold a knife, knife sharpening steel, letter opener, hammer, screwdriver, pliers, socket wrench, paint brush, chisel, file, wooden spoon, spatula, whisk, ice cream scoop, can opener, bottle opener, baster, apple corer, cork screw, pie/cake server, fish scaler, garlic press, honey dipper, ladle, lemon reamer, meat tenderizer, melon bailer, nutcracker, pastry brush, peeler, potato masher, pizza cutter, zester, or tongs.

The present invention makes better use of the rolled materials dispenser by giving it a second purpose. The shaft of a rolled materials dispenser is a sturdy and safe place to keep a pair of scissors or shears. Unlike a slot in a knife block, this invention can accommodate a variety of sizes and styles of scissors or shears. Pairing scissors with paper towels makes them logical companions and scissors are easier to find and return to their proper place. The handles of the scissors/shears at the top of the dispenser provide a new decorative and functional appeal.

To make the present invention, an individual could take a round, seamless stainless-steel tube (approximately 10″ h.×1″ dia.; 1/32″″ thick) that is hollow at the top and has an integrated female threaded nut at bottom and attach the tube to a round weighted stainless steel-covered base (approximately 6″ dia.×¾″ h.) using a washer and threaded bolt. At the top of the tube that has interior threading, fasten a stopper bolt that screws on to the top edge of the tube while providing an opening that supports a closed pair of scissors or shears in the tube while the handles of the scissors are displayed above the tube and the rolled material on the tube. Change the stopper bolt to accommodate larger or smaller scissors/shears. Add a thin silicone rubber mat with a center hole to the bottom of the base for a non-skid solution. To add color to the design, cover the stainless steel-covered weighted base with a round plastic base cover with center hole that comes in a variety of colors.

It should be understood, of course, that the foregoing relates to exemplary embodiments of the invention and that modifications may be made without departing from the spirit and scope of the invention as set forth in the following claims.

What is claimed is:

1. A kit for operatively dispensing rolled material and simultaneously storing elongated tapered objects, comprising:
a base;
a tubular element extending from a distal end to a proximal end, the proximal end transversely connected to the base;
a plurality of stopper bolts, each stopper bolt providing a body and a flange portion, wherein a flange diameter of the flange portion is greater than a body diameter of the body, and wherein the body diameter fits within a lumen of the tubular element, while the flange diameter does not; and
a donut opening disposed in each flange portion.

2. The kit of claim 1, wherein the lumen and each body provides cooperating threading.

3. The kit of claim 1, wherein each body provides at least one staggered opening, each staggered opening having a diameter greater than a diameter of the respective donut opening.

4. The kit of claim 1, wherein each flange portion provides a diameter of the donut opening that differs among the plurality of stopper bolts.

5. The kit of claim 1, wherein the elongated tapered object is a pair of blades of a pair of scissors.

6. The kit of claim 1, wherein the elongated tapered object is a pair of blades of a pair of scissors, and wherein the pair of blades are slidably received through the donut hole of one of the plurality of stopper bolts.

7. A kit for operatively dispensing rolled material and simultaneously storing elongated tapered objects, comprising:
a base;
a tubular element extending from a distal end to a proximal end, the proximal end transversely connected to the base;
a plurality of stopper bolts, each stopper bolt providing a body and a flange portion, wherein a flange diameter of the flange portion is greater than a body diameter of the body, and wherein the body diameter fits within a lumen of the tubular element, while the flange diameter does not;
a donut opening disposed in each flange portion;
each flange portion provides a diameter of the donut opening that differs among the plurality of stopper bolts;
the lumen and each body provides cooperating threading; and
each body provides at least one staggered opening, each staggered opening having a diameter greater than a diameter of the respective donut opening.
